(19) United States
(12) Patent Application Publication
(10) Pub. No.: US 2007/0154713 A1
(43) Pub. Date: Jul. 5, 2007

(54) Ceramic cutting tools and cutting tool inserts, and methods of making the same

(75) Inventors: Anatoly Z. Rosenflanz, Maplewood, MN (US); Thomas J. Anderson, Woodbury, MN (US); Berkan K. Endres, Woodbury, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/323,452

(22) Filed: Dec. 30, 2005

(51) Int. Cl. B32B 9/00; B32B 19/00

(52) U.S. Cl. 428/408; 428/701; 428/702; 428/697; 428/698

(57) ABSTRACT

Ceramic cutting tools and cutting tool inserts comprising a continuous glass-ceramic matrix and a dispersed phase selected from the group consisting of carbides, borides, nitrides, diamond, and combinations thereof.

### BACKGROUND

Ceramic materials comprising alumina along with other metal oxides are known in the art. These materials are generally recognized for their fracture toughness and strength characteristics. There is a continuing desire for new ceramic materials with relatively high fracture toughness and strength characteristics for cutting tools and cutting tool inserts, as well as methods for making the same.

### SUMMARY

In one aspect, the present invention provides cutting tools and cutting tool inserts comprising:

a continuous glass-ceramic matrix comprising at least 35 (in some embodiments, at least 40, 45, 50, 55, 60, 65, 70, 75, 80, 85, or even at least 90) percent by weight Al₂O₃, based on the total weight of the glass-ceramic matrix, and a metal oxide other than Al₂O₃ (e.g., Y₂O₃, REO, ZrO₂, TiO₂, CaO, Cr₂O₃, MgO, NiO, CuO, and complex metal oxides thereof), wherein the glass-ceramic contains not more than 10 (in some embodiments preferably, less than 5, 4, 3, 2, 1, or even zero) percent by weight collectively AS₂O₃, B₂O₃, Bi₂O₃, GeO₂, P₂O₅, SiO₂, TeO₂, and V₂O₅ (in some embodiments, alkaline and alkaline earth metal oxides also), based on the total weight of the glass-ceramic, wherein the glass-ceramic has a plurality of cells having an average cell size of less than 3 micrometers (in some embodiments, less than 2, 1, 0.75, or even less than 0.5 micrometers); and

a dispersed phase selected from the group consisting of carbide, borides, nitrides, diamond, and combinations thereof.

In some embodiments, the cutting tool or cutting tool insert has x, y, and z dimensions each perpendicular to each other, wherein each of the x and y dimensions is at least 5 mm (in some embodiments, at least 6, 7, 8, 9, or even at least 10 mm). Optionally, the z dimension in some embodiments is at least 1 mm (in some embodiments, at least 2, 3, 4, or even at least 5 mm).

The x, y, and z dimensions of a material are determined either visually or using microscopy, depending on the magnitude of the dimensions. The reported x dimension is, for example, the diameter of a sphere, the thickness of a coating, or the longest length of a prismatic shape.

In some embodiments, the continuous glass-ceramic matrix comprises at least 10 percent (in some embodiments at least 15, 20, 25, 30, or 35 percent) by weight of the metal oxide other than Al₂O₃ (e.g., Y₂O₃, REO, ZrO₂, TiO₂, CaO, Cr₂O₃, MgO, NiO, CuO, and complex metal oxides thereof), based on the total weight of the glass-ceramic.

In another aspect, the present invention provides a cutting tool insert or cutting tool comprising a continuous glass-ceramic matrix, and a dispersed phase selected from the group consisting of carbides, borides, nitrides, diamond, and combinations thereof, wherein the cutting tool insert has a hardness of at least 15 GPa (in some embodiments, 16, 17, 18, or even 19 GPa) and a flexural strength of at least 400 MPa (in some embodiments, 500 or even 600 MPa).

In another aspect, the present invention provides a method for making cutting tools or cutting tool inserts, the method comprising:
providing a plurality of glass bodies having an average particle size of less than 3 micrometers (in some embodiments, less than 2, 1, 0.75, or even less than 0.5 micrometers), wherein the glass bodies comprise at least 35 percent by weight Al₂O₃, based on the total weight of the glass bodies, and a metal oxide other than Al₂O₃, wherein the glass bodies contains not more than 10 percent by weight collectively As₂O₃, B₂O₃, Bi₂O₃, GeO₂, P₂O₅, SiO₂, TeO₂, and V₂O₅, based on the total weight of the glass bodies, wherein the glass bodies have a T_{g} and Tₓ, and wherein the difference between the T_{g} and the Tₓ of the glass bodies is at least 5K; and
dispersing a material selected from the group consisting of carbides, borides, nitrides, diamond, and combinations thereof in the plurality of glass bodies;
heating the glass bodies above the T_{g} and coalescing at least a portion of the plurality of glass bodies to form a composite body; and
heat-treating the composite body to provide a cutting tool or cutting tool insert. In some embodiments, the glass bodies are reduced to a size of 3 micrometers by milling a plurality of precursor glass bodies to form the glass bodies.

In some embodiments, the heating of the glass bodies above the T_{g} and the heat-treating of the composite body are accomplished in one step.

The cutting tools and cutting tool inserts of the present invention can be used in various applications, including for example, drilling, boring, facing, turning, dimensioning, and other known machining and cutting operations known to those skilled in the art. The cutting tools and cutting tool inserts of the present invention can be used to machine or cut a variety of materials, including, for example, metals, plastics, wood, and ceramics.

In this application:

“amorphous material” refers to material derived from a melt and/or a vapor phase that lacks any long range crystal structure as determined by X-ray diffraction and/or has an exothermic peak corresponding to the crystallization of the amorphous material as determined by a DTA (differential thermal analysis) as determined by the test described herein entitled “Differential Thermal Analysis”;

“cell” refers to the smallest structural unit of a ceramic material that forms at least two distinct crystalline phases if the ceramic material is crystallized. In an amorphous material, a cell is essentially uniform in composition and essentially free of microstructural features (e.g., grain boundaries). In the context of the present invention, an individual cell generally corresponds to the individual body (e.g., particle, glass body, etc.) that is coalesced with a plurality of other bodies to form a larger consolidated ceramic material. The size of a cell can be determined using metallography and microscopic methods known in the art (e.g., SEM, TEM).

“ceramic” includes glass, crystalline ceramic, glass-ceramic, and combinations thereof;

“complex metal oxide” refers to a metal oxide comprising two or more different metal elements and oxygen (e.g., CeAl₁₁O₁₈, Dy₃Al₅O₁₂, MgAl₂O₄, and Y₃Al₅O₁₂);

“complex Al₂O₃.metal oxide” refers to a complex metal oxide comprising, on a theoretical oxide basis, Al₂O₃ and one or more metal elements other than Al (e.g., CeAl₁₁O₁₈, Dy₃Al₅O₁₂, MgAl₂O₄, and Y₃Al₅O₁₂);

“complex Al₂O₃.Y₂O₃” refers to a complex metal oxide comprising, on a theoretical oxide basis, Al₂O₃ and Y₂O₃ (e.g., Y₃Al₅O₁₂);

“complex Al₂O₃.REO” refers to a complex metal oxide comprising, on a theoretical oxide basis, Al₂O₃ and rare earth oxide (e.g., CeAl₁₁O₁₈ and Dy₃Al₅O₁₂)

“glass” refers to amorphous material exhibiting a glass transition temperature;

“glass-ceramic” refers to ceramic comprising crystals formed by heat-treating glass;

“T_{g}” refers to the glass transition temperature as determined by the test described herein entitled “Differential Thermal Analysis”;

“Tₓ” refers to the crystallization temperature as determined by the test described herein entitled “Differential Thermal Analysis”;

“rare earth oxides” refers to cerium oxide (e.g., CeO₂), dysprosium oxide (e.g., Dy₂O₃), erbium oxide (e.g., Er₂O₃), europium oxide (e.g., Eu₂O₃), gadolinium oxide (e.g., Gd₂O₃), holmium oxide (e.g., H₂O₃), lanthanum oxide (e.g., La₂O₃), lutetium oxide (e.g., Lu₂O₃), neodymium oxide (e.g., Nd₂O₃), praseodymium oxide (e.g., Pr₆O₁₁), samarium oxide (e.g., Sm₂O₃), terbium oxide (e.g., Tb₂O₃), thorium oxide (e.g., Th₄O₇), thulium oxide (e.g., Tm₂O₃), and ytterbium oxide (e.g., Yb₂O₃), and combinations thereof; and

“REO” refers to rare earth oxide(s).

Further, it is understood herein that unless it is stated that a metal oxide (e.g., Al₂O₃, complex Al₂O₃.metal oxide, etc.) is crystalline, for example, in a glass-ceramic, it may be glass, crystalline, or portions glass and portions crystalline. For example, if a glass-ceramic comprises Al₂O₃ and ZrO₂, the Al₂O₃ and ZrO₂ may each be in a glassy state, crystalline state, or portions in a glassy state and portions in a crystalline state, or even as a reaction product with another metal oxide(s) (e.g., unless it is stated that, for example, Al₂O₃ is present as crystalline Al₂O₃ or a specific crystalline phase of Al₂O₃ (e.g., alpha Al₂O₃), it may be present as crystalline Al₂O₃ and/or as part of one or more crystalline complex Al₂O₃.metal oxides).

### BRIEF DESCRIPTION OF THE DRAWINGS

FIG. 1 is a side view of an exemplary embodiment of an apparatus including a powder feeder assembly for a flame-melting apparatus.

FIG. 2 is a section view of the apparatus of FIG. 1.

FIG. 3 is an exploded section view of the apparatus of FIG. 1.

FIG. 4 is a side view of a portion of the powder feeder assembly of FIG. 1.

FIG. 5 is a perspective view of a portion of the powder feeder assembly of FIG. 1.

FIG. 6 is a cross-sectional view of a portion of the powder feeder assembly of FIG. 1.

FIG. 7 is a perspective view of an exemplary cutting tool.

FIG. 8 is a SEM micrograph of Example 4.

FIGS. 9 and 10 are SEM micrographs of Example 6.

### DETAILED DESCRIPTION

The present invention pertains to ceramic composite materials and methods of making ceramics for use in cutting tools and cutting tool inserts. The ceramic composite material is prepared by selecting the necessary raw materials and processing techniques.

Sources, including commercial sources, for the metal oxides include the oxides themselves, metal powders, complex oxides, ores, carbonates, acetates, nitrates, chlorides, hydroxides, etc.

For example, sources, including commercial sources, of (on a theoretical oxide basis) Al₂O₃ include bauxite (including both natural occurring bauxite and synthetically produced bauxite), calcined bauxite, hydrated aluminas (e.g., boehmite, and gibbsite), aluminum, Bayer process alumina, aluminum ore, gamma alumina, alpha alumina, aluminum salts, aluminum nitrates, and combinations thereof. The Al₂O₃ source may contain, or only provide, Al₂O₃. The Al₂O₃ source may contain, or provide Al₂O₃, as well as one or more metal oxides other than Al₂O₃ (including materials of or containing complex Al₂O₃.metal oxides (e.g., Dy₃Al₅O₁₂, Y₃Al₅O₁₂, CeAl₁₁O₁₈, etc.)).

Sources, including commercial sources, of rare earth oxides include rare earth oxide powders, rare earth metals, rare earth-containing ores (e.g., bastnasite and monazite), rare earth salts, rare earth nitrates, and rare earth carbonates. The rare earth oxide(s) source may contain, or only provide, rare earth oxide(s). The rare earth oxide(s) source may contain, or provide rare earth oxide(s), as well as one or more metal oxides other than rare earth oxide(s) (including materials of or containing complex rare earth oxide other metal oxides (e.g., Dy₃Al₅O₁₂, CeAl₁₁O₁₈, etc.)).

Sources, including commercial sources, of (on a theoretical oxide basis) Y₂O₃ include yttrium oxide powders, yttrium, yttrium-containing ores, and yttrium salts (e.g., yttrium carbonates, nitrates, chlorides, hydroxides, and combinations thereof). The Y₂O₃ source may contain, or only provide, Y₂O₃. The Y₂O₃ source may contain, or provide Y₂O₃, as well as one or more metal oxides other than Y₂O₃ (including materials of or containing complex Y₂O₃.metal oxides (e.g., Y₃Al₅O₁₂)).

For embodiments comprising ZrO₂ and HfO₂, the weight ratio of ZrO₂:HfO₂ may be in a range of 1:zero (i.e., all ZrO₂; no HfO₂) to zero:1, as well as, for example, at least about 99, 98, 97, 96, 95, 90, 85, 80, 75, 70, 65, 60, 55, 50, 45, 40, 35, 30, 25, 20, 15, 10, and 5 parts (by weight) ZrO₂ and a corresponding amount of HfO₂ (e.g., at least about 99 parts (by weight) ZrO₂ and not greater than about 1 part HfO₂) and at least about 99, 98, 97, 96, 95, 90, 85, 80, 75, 70, 65, 60, 55, 50, 45, 40, 35, 30, 25, 20, 15, 10, and 5 parts HfO₂ and a corresponding amount of ZrO₂.

Sources, including commercial sources, of (on a theoretical oxide basis) ZrO₂ include zirconium oxide powders, zircon sand, zirconium, zirconium-containing ores, and zirconium salts (e.g., zirconium carbonates, acetates, nitrates, chlorides, hydroxides, and combinations thereof). In addition, or alternatively, the ZrO₂ source may contain, or provide ZrO₂, as well as other metal oxides such as hafnia. Sources, including commercial sources, of (on a theoretical oxide basis) HfO₂ include hafnium oxide powders, hafnium, hafnium-containing ores, and hafnium salts. In addition, or alternatively, the HfO₂ source may contain, or provide HfO₂, as well as other metal oxides such as ZrO₂.

In some embodiments, it may be advantageous for at least a portion of a metal oxide source (in some embodiments, 10, 15, 20, 25, 30, 35, 40, 45, 50, 55, 60, 65, 70, 75, 80, 85, 90, 95, or even 100 percent by weight) to be obtained by adding particulate, metallic material comprising at least one of a metal (e.g., Al, Ca, Cu, Cr, Fe, Li, Mg, Ni, Ag, Ti, Zr, and combinations thereof), M, that has a negative enthalpy of oxide formation or an alloy thereof to the melt, or otherwise combining them with the other raw materials. Although not wanting to be bound by theory, it is believed that the heat resulting from the exothermic reaction associated with the oxidation of the metal is beneficial in the formation of a homogeneous melt and resulting glass. For example, it is believed that the additional heat generated by the oxidation reaction within the raw material eliminates, minimizes, or at least reduces insufficient heat transfer, and hence facilitates formation and homogeneity of the melt. It is also believed that the availability of the additional heat aids in driving various chemical reactions and physical processes (e.g., densification, and spherodization) to completion. Further, it is believed for some embodiments, the presence of the additional heat generated by the oxidation reaction actually enables the formation of a melt, which otherwise is difficult or not practical due to high melting point of the materials. Further, the presence of the additional heat generated by the oxidation reaction actually enables the formation of glass that otherwise could not be made, or could not be made in the desired size range. Another advantage of the invention includes, in forming the glasses, that many of the chemical and physical processes such as melting, densification and spherodizing can be achieved in a short time, so that very high quench rates may be achieved. For additional details, see U.S. Publication No. US2003-0110709A1, published Jun. 16, 2003.

In some embodiments, for example, the raw materials are fed independently to form the molten mixture. In some embodiments, for example, certain raw materials are mixed together, while other raw materials are added independently into the molten mixture. In some embodiments, for example, the raw materials are combined or mixed together prior to melting. The raw materials may be combined, for example, in any suitable and known manner to form a substantially homogeneous mixture. These combining techniques include ball milling, mixing, tumbling, and the like. The milling media in the ball mill may be metal balls, ceramic balls, and the like. The ceramic milling media may be, for example, alumina, zirconia, silica, magnesia and the like. The ball milling may occur dry, in an aqueous environment, or in a solvent-based (e.g., isopropyl alcohol) environment. If the raw material batch contains metal powders, then it is generally desired to use a solvent during milling. This solvent may be any suitable material with the appropriate flash point and ability to disperse the raw materials. The milling time may be from a few minutes to a few days, generally between a few hours to 24 hours. In a wet or solvent based milling system, the liquid medium is removed, typically by drying, so that the resulting mixture is typically homogeneous and substantially devoid of the water and/or solvent. If a solvent based milling system is used, during drying, a solvent recovery system may be employed to recycle the solvent. After drying, the resulting mixture may be in the form of a “dried cake”. This cake-like mixture may then be broken up or crushed into the desired particle size prior to melting. Alternatively, for example, spray-drying techniques may be used. The latter typically provides spherical particulates of a desired mixture. The precursor material may also be prepared by wet chemical methods including precipitation and sol-gel. Such methods will be beneficial if extremely high levels of homogeneity are desired.

Particulate raw materials are typically selected to have particle sizes such that the formation of a homogeneous melt can be achieved rapidly. Typically, raw materials with relatively small average particle sizes and narrow distributions are used for this purpose. In some methods (e.g., flame forming and plasma spraying), particularly desirable particulate raw materials are those having an average particle size in a range from about 5 nm to about 50 micrometers (in some embodiments, in a range from about 10 nm to about 20 micrometers, or even about 15 nm to about 1 micrometer), although sizes outside of the sizes and ranges may also be useful. Particulate less than about 5 nm in size tends to be difficult to handle (e.g., the flow properties of the feed particles tended to be undesirable as they tend to have poor flow properties). Use of particulate larger than about 50 micrometers in typical flame forming or plasma spraying processes tend to make it more difficult to obtain homogenous melts and glasses and/or the desired composition.

Furthermore, in some cases, for example, when particulate material is fed in to a flame or thermal or plasma spray apparatus, to form the melt, it may be desirable for the particulate raw materials to be provided in a range of particle sizes, including agglomerated forms.

Amorphous materials, including glasses, can be made, for example, by heating (including in a flame or plasma) the appropriate metal oxide sources to form a melt, desirably a homogenous melt, and then rapidly cooling the melt to provide amorphous material. Some embodiments of amorphous material can be made, for example, by melting the metal oxide sources in any suitable furnace (e.g., an inductively or resistively heated furnace, a gas-fired furnace, or an electric arc furnace).

The amorphous material is typically obtained by relatively rapidly cooling the molten material (i.e., the melt). The quench rate (i.e., the cooling time) to obtain the amorphous material depends upon many factors, including the chemical composition of the melt, the amorphous material-forming ability of the components, the thermal properties of the melt and the resulting amorphous material, the processing technique(s), the dimensions and mass of the resulting amorphous material, and the cooling technique. In general, relatively higher quench rates are required to form amorphous materials comprising higher amounts of Al₂O₃, especially in the absence of known glass formers such as As₂O₃, Bi₂O₃, B₂O₃, GeO₂, P₂O₅, SiO₂, TeO₂, V₂O₅, alkaline oxides, and alkaline earth oxides. Similarly, it is more difficult to cool melts into amorphous materials in larger dimensions, as it is more difficult to remove heat fast enough.

In some embodiments of the invention, the raw materials are heated into a molten state in a particulate form and subsequently cooled into glass particles. Typically, the particles have a particle size greater than 25 micrometers (in some embodiments, greater than 50, 100, 150, or even 200 micrometers).

The quench rates achieved in making amorphous materials according to the methods of the present invention are believed to be higher than 10², 10³, 10⁴, 10⁵ or even 10⁶° C./sec (i.e., a temperature drop of 1000° C. from a molten state in less than 10 seconds, less than a second, less than a tenth of a second, less than a hundredth of a second or even less than a thousandth of a second, respectively). Techniques for cooling the melt include discharging the melt into a cooling media (e.g., high velocity air jets, liquids (e.g., cold water), metal plates (including chilled metal plates), metal rolls (including chilled metal rolls), metal balls (including chilled metal balls), and the like). Other cooling techniques known in the art include roll-chilling. Roll-chilling can be carried out, for example, by melting the metal oxide sources at a temperature typically 20-200° C. higher than the melting point, and cooling/quenching the melt by spraying it under high pressure (e.g., using a gas such as air, argon, nitrogen or the like) onto a high-speed rotary roll(s). Typically, the rolls are made of metal and are water-cooled. Metal book molds may also be useful for cooling/quenching the melt.

The cooling rate is believed to affect the properties of the quenched amorphous material. For instance, glass transition temperature, density and other properties of glass typically change with cooling rates.

Rapid cooling may also be conducted under controlled atmospheres, such as a reducing, neutral, or oxidizing environment to maintain and/or influence the desired oxidation states, etc. during cooling. The atmosphere can also influence glass formation by influencing crystallization kinetics from undercooled liquid. For example, larger undercooling of Al₂O₃ melts without crystallization has been reported in argon atmosphere as compared to that in air.

In one method, amorphous materials can be made utilizing flame fusion as reported, for example, in U.S. Pat. No. 6,254,981 (Castle). In this method, the metal oxide source(s) are fed (e.g., in the form of particles, sometimes referred to as “feed particles”) directly into a burner (e.g., a methane-air burner, an acetylene-oxygen burner, a hydrogen-oxygen burner, and the like), and then quenched, for example, in water, cooling oil, air, or the like. Feed particles can be formed, for example, by grinding, agglomerating (e.g., spray-drying), melting, or sintering the metal oxide sources. The size of feed particles fed into the flame generally determines the size of the resulting amorphous particles.

Some embodiments of glasses can also be obtained by other techniques, such as: laser spining melt with free fall cooling, Taylor wire technique, plasmatron technique, hammer and anvil technique, centrifugal quenching, air gun splat cooling, single roller and twin roller quenching, roller-plate quenching, and pendant drop melt extraction (see, e.g., Rapid Solidification of Ceramics, Brockway et al., Metals And Ceramics Information Center, A Department of Defense Information Analysis Center, Columbus, Ohio, January, 1984). Some embodiments of glasses may also be obtained by other techniques, such as: thermal (including flame or laser or plasma-assisted) pyrolysis of suitable precursors, physical vapor synthesis (PVS) of metal precursors and mechanochemical processing. Other techniques for forming melts, cooling/quenching melts, and/or otherwise forming glass include melt-extraction, and gas or centrifugal atomization.

Gas atomization involves heating feed particles to convert them to melt. A thin stream of such melt is atomized through contact with a disruptive air jet (i.e., the stream is divided into fine droplets). The resulting substantially discrete, generally ellipsoidal glass particles (e.g., beads) are then recovered. Examples of bead sizes include those having a diameter in a range of about 5 micrometers to about 3 mm. Melt-extraction can be carried out, for example, as reported in U.S. Pat. No. 5,605,870 (Strom-Olsen et al.). Container-less glass forming techniques utilizing laser beam heating as reported, for example, in U.S. Pat. No. 6,482,758 (Weber), may also be useful in making glasses useful in the present invention.

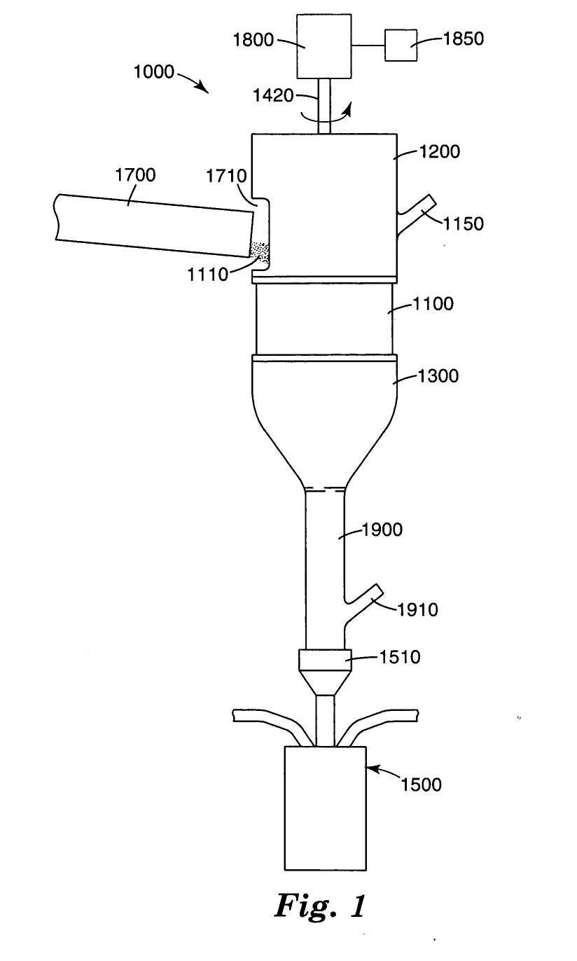

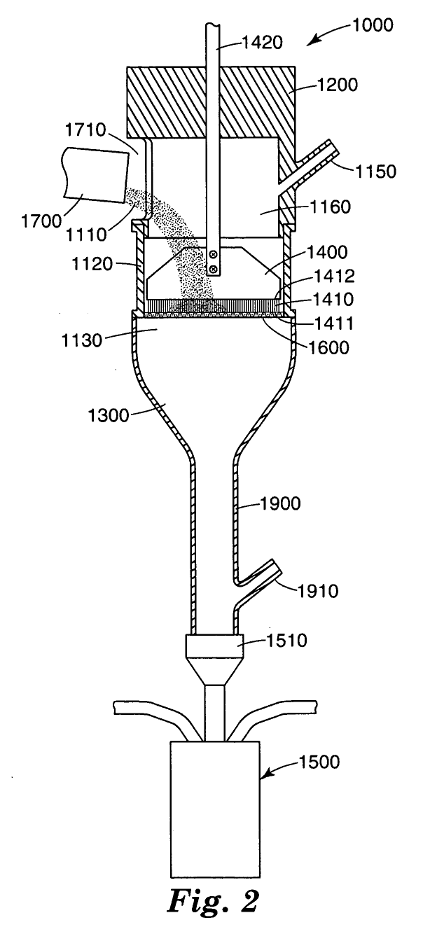

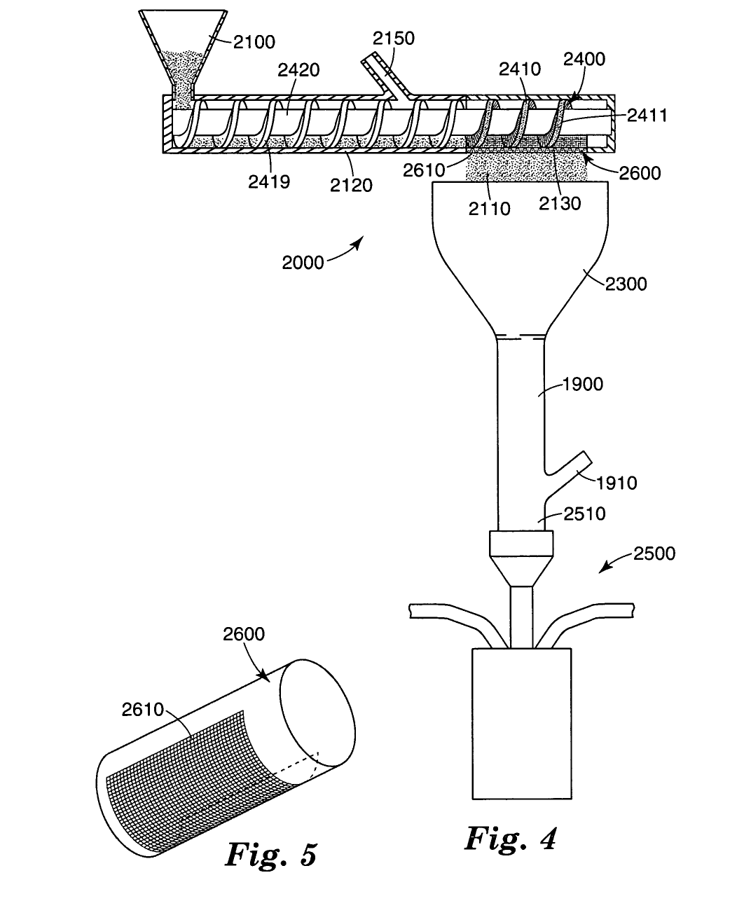

An exemplary powder feeder apparatus is illustrated in FIGS. 1-6. The powder feeder assembly 1000 holds and delivers powder 1110 to a flame-melting device 1500. Flame-melting device 1500 includes powder receiving section 1510 for receiving powder 1110 for melting and transforming into another material(s), such as those disclosed herein. Powder 1110 is delivered into powder receiving section 1510 through discharge opening 1130 of powder feeder assembly 1000. Connecting tube 1900 is positioned between discharge opening 1130 and powder receiving section 1510. Also, funnel 1300 is positioned proximate to discharge opening 1130 for receiving and directing powder 1110 flow after it leaves discharge opening 1130.

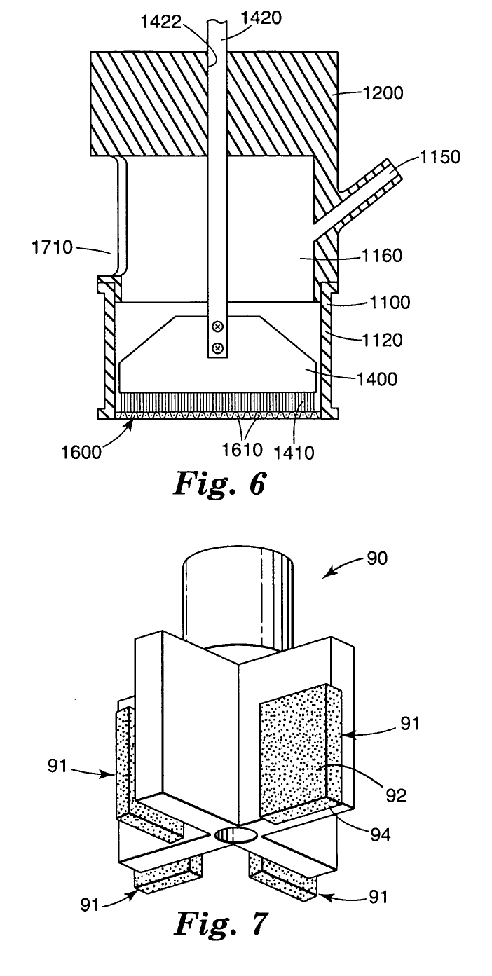

Powder feeder assembly 1000 includes hopper 1100 or holding powder 1110. Typically, hopper 1100 includes body 1120 defined by a cylindrical wall, though other body shapes are possible. Also, hopper 1100 can be made from a unitary piece or multiple pieces. Hopper 1100 in the example embodiment illustrated also includes cover section 1200. Cover section 1200 includes opening 1710 for feeding powder 1110 into hopper 1100. Any commercially available delivery means can be used for filling hopper 1100 with powder 1110, such as a screw feeder, vibratory feeder, or brush feeder. Cover section 1200 can also include a section having shaft receiving opening 1422 (as illustrated in FIG. 6).

Brush assembly 1400 is disposed within hopper 1100 body 1120. Brush assembly 1400 is connected to means for rotating brush assembly 1400, such as motor 1800. Motor 1800 can also be connected to means for adjusting the speed of motor 1800, such as motor speed controller 1850. The brush assembly can use, for example a Nylon Strip Brush (e.g., (1 inch (2.5 cm) overall height, 5/16 inch (0.8 cm) bristle length and 0.02 inch (5 millimeter) diameter), part# 74715T61, available from McMaster-Carr, Chicago, Ill.). The brush assembly is coupled to a shaft, which in turn is coupled to and driven by a DC Gear Motor (130 Volt, Ratio 60:1, Torque 22 lb. in.) (available, for example, from Bodine Electric Company, Chicago, Ill.). The speed of the motor can be controlled using an adjustable motor control (e.g., a Type-FPM Adjustable Speed PM Motor Control, Model # 818, also available from Bodine.

Brush assembly 1400 includes bristle element 1410 having distal 1411 and proximate end 1412. When powder 1110 is placed into hopper 1100 for delivery to flame-melting device 1500, brush assembly 1400 is rotated within hopper 1100. When brush assembly 1400 is rotated, bristle element(s) 1410 urges powder 1110 in hopper 1100 through screening member 1600. By adjusting the rotational speed of brush assembly 1400, the feed rate of powder 1110 through screening member 1600 can be controlled.

Brush assembly 1400 cooperates with screening member 1600 to deliver powder 1110 having desired properties from discharge opening 1130 to powder receiving section 1510 of flame-melting device 1500. Distal end 1411 of bristle 1410 is located in close proximity to screening member 1600. While a small gap between distal end 1411 of bristles 1410 and screening member 1600 can be used, it is typical to keep the gap on the same order of magnitude as the particle size of the powder, however, one of ordinary skill in the art will appreciate that the gap can be much larger, depending on the particular properties of the powder being handled. Also, distal end 1411 of bristle 1410 can be positioned flush with screening member 1600 or positioned to protrude into and extend through mesh openings 1610 in screening member 1600. For bristles 1410 to protrude through openings 1610, at least some of bristles 1410 need to have a diameter smaller than the mesh size. Bristle elements 1410 can include a combination of bristles with different diameters and lengths, and any particular combination will depend on the operating conditions desired.

Extending bristle 1400 end 1411 into and through openings 1610 allows bristles 1410 to break up any particles forming bridges across openings 1610. Also bristles 1410 will tend to break-up other types of blockages that can occur typical to powder feeding. Bristle element 1410 can be a unitary piece, or can also be formed from a plurality of bristle segments. Also, if it is desired that the bristle elements extend into and/or through the mesh openings, then bristle 1410 size selected needs to be smaller than smallest mesh opening 1610.

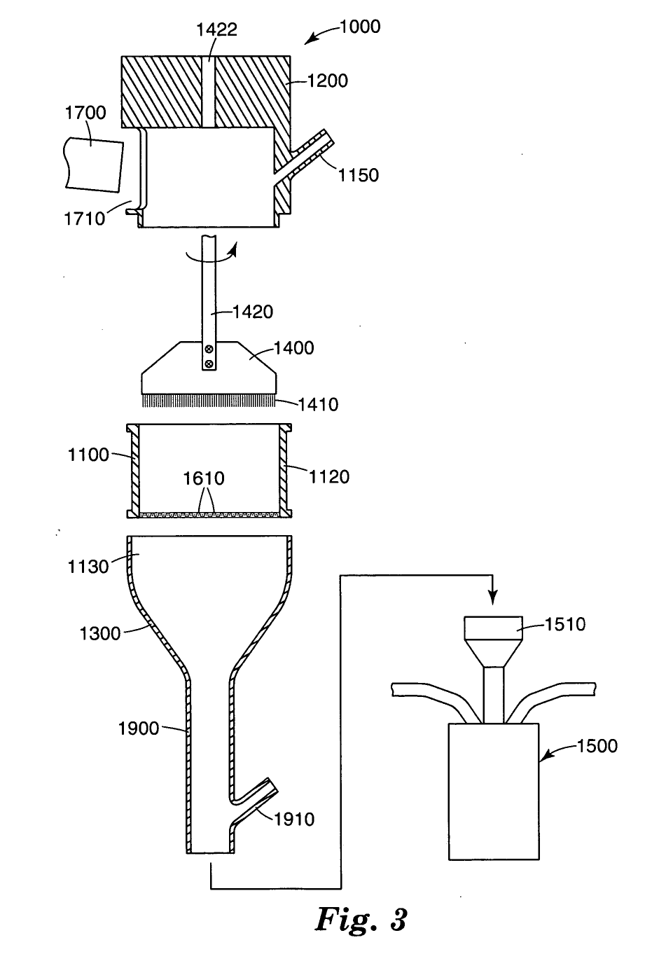

Referring to FIG. 3, in the exemplary embodiment illustrated, hopper 1100 can include a wall defining a cylindrical body 1120. This shape conveniently provides for symmetry that allows for a more controlled flow rate of powder from discharge opening 1130. Also, the cylindrical shape is well suited for using with rotating brush assembly 1400, since bristle element 1410 can extend to the wall, leaving little or no area on the screening member that can accumulate powder. However, other geometries are possible, as the particular conditions of use dictate.

Hopper 1100 also includes cover section 1200. Cover section 1200 has opening 1710 for receiving powder 1110 from hopper feeder assembly 1700. Cover section 1200 cooperates with body 1120 to form powder chamber 1160. Opening 1710 on cover 1200 can also be omitted or sealable so that a gas, such as nitrogen, argon, or helium can be input into gas input line 1150 on hopper 1100 for neutralizing the atmosphere or assisting in delivering the powder or particles to the flame-melting device. Also, gas can be used in the system for controlling the atmosphere surrounding the powder or particles. Also, gas input line 1910 can be placed after discharge opening 1130, for example, on connecting tube 1900.

Entire powder feeder assembly 1000 can be vibrated to further assist in powder transport. Optionally, the screening member can be vibrated to assist powder transport through powder feeder assembly 1000. One of ordinary skill in the art will recognize that other possible vibrating means can be used, and there are abundant commercial vibrating systems and devices that are available depending on the particular conditions of use.

Referring to FIGS. 1-6, when hopper 1100 includes cover 1200 and body 1120, removable cover 1200 allows easy access to powder chamber 1160 for cleaning or changing screening member 1600. Also, brush assembly 1400 can be positioned to form the desired engagement between bristle elements 1410 and screening member 1600. When brush assembly 1400 is attached to rotating shaft 1420, shaft 1420 can protrude outside opening 1422 in cover 1200 to be driven, for example, by motor 1800. The speed of brush assembly 1400 can be controlled by means such as speed controller 1850. Further details regarding this exemplary powder feeding apparatus can be found in see U.S. Publication No. US2005-0133974A1, published Jun. 23, 2005.

The addition of certain metal oxides may alter the properties and/or crystalline structure or microstructure of ceramics utilized in the present invention, as well as the processing of the raw materials and intermediates in making the ceramic. For example, oxide additions such as MgO, CaO, Li₂O, and Na₂O have been observed to alter both the T_{g} and Tₓ (wherein Tₓ is the crystallization temperature) of glass. Although not wishing to be bound by theory, it is believed that such additions influence glass formation. Further, for example, such oxide additions may decrease the melting temperature of the overall system (i.e., drive the system toward lower melting eutectic), and ease glass formation. Compositions based upon complex eutectics in multi-component systems (quaternary, etc.) may have better glass-forming ability. The viscosity of the liquid melt and viscosity of the glass in its' working range may also be affected by the addition of metal oxides other than the particular required oxide(s).

Crystallization of glasses and ceramics comprising the glass to form glass-ceramics may also be affected by the additions of materials. For example, certain metals, metal oxides (e.g., titanates and zirconates), and fluorides may act as nucleation agents resulting in beneficial heterogeneous nucleation of crystals. Also, addition of some oxides may change the nature of metastable phases devitrifying from the glass upon reheating. In another aspect, for ceramics according to the present invention comprising crystalline ZrO₂, it may be desirable to add metal oxides (e.g., Y₂O₃, TiO₂, CeO₂, CaO, and MgO) that are known to stabilize the tetragonal/cubic form of ZrO₂.

The particular selection of metal oxide sources and other additives for making ceramics utilized in the present invention typically takes into account, for example, the desired composition, the microstructure, the degree of crystallinity, the physical properties (e.g., hardness or toughness), the presence of undesirable impurities, visual appearance (e.g., coloration), and the desired or required characteristics of the particular process (including equipment and any purification of the raw materials before and/or during fusion and/or solidification) being used to prepare the ceramics.

In some instances, it may be preferred to incorporate limited amounts of metal oxides selected from the group consisting of: B₂O₃, Bi₂O₃, Na₂O, P₂O₅, SiO₂, TeO₂, V₂O₅, alkaline oxides, and alkaline earth oxides, and combinations thereof. Sources, including commercial sources, include the oxides themselves, complex oxides, elemental (e.g., Si) powders, ores, carbonates, acetates, nitrates, chlorides, hydroxides, etc. These metal oxides may be added, for example, to modify a physical property of the resulting glass-ceramic and/or improve processing. These metal oxides, when used, are typically added from greater than 0 to 10% by weight collectively (in some embodiments, greater than 0 to 5% by weight collectively, or even greater than 0 to 2% by weight collectively) of the glass-ceramic depending, for example, upon the desired property.

Useful formulations include those at or near a eutectic composition(s) (e.g., ternary eutectic compositions). In addition to compositions disclosed herein, other such compositions, including quaternary and other higher order eutectic compositions, may be apparent to those skilled in the art after reviewing the present disclosure.

The microstructure or phase composition (glassy/crystalline) of a material can be determined in a number of ways, including optical microscopy, electron microscopy, differential thermal analysis (DTA), and x-ray diffraction (XRD).

Using optical microscopy, amorphous material is typically predominantly transparent due to the lack of light scattering centers such as crystal boundaries, while crystalline material shows a crystalline structure and is opaque due to light scattering effects.

A percent amorphous (or glass) yield can be calculated for particles (e.g., beads), etc. using a −100+120 mesh size fraction (i.e., the fraction collected between 150-micrometer opening size and 125-micrometer opening size screens). The measurements are done in the following manner. A single layer of particles, beads, etc. is spread out upon a glass slide. The particles, beads, etc. are observed using an optical microscope. Using the crosshairs in the optical microscope eyepiece as a guide, particles, beads, etc. that lay along a straight line are counted either amorphous or crystalline depending on their optical clarity (i.e., amorphous if they were clear). A total of 500 particles, beads, etc. are typically counted, although fewer particles, beads, etc. may be used and a percent amorphous yield is determined by the amount of amorphous particles, beads, etc. divided by total particles, beads, etc. counted. Embodiments of methods for making the amorphous (or glass) may have yields of at least 50, 60, 70, 75, 80, 85, 90, 95, or even 100 percent.

If it is desired for all the particles to be amorphous (or glass), and the resulting yield is less than 100%, the amorphous (or glass) particles may be separated from the non-amorphous (or non-glass) particles. Such separation may be done, for example, by any conventional techniques, including separating based upon density or optical clarity.

Using DTA, the material is classified as amorphous if the corresponding DTA trace of the material contains an exothermic crystallization event (Tₓ). If the same trace also contains an endothermic event (T_{g}) at a temperature lower than Tₓ it is considered to consist of a glass phase. If the DTA trace of the material contains no such events, it is considered to contain crystalline phases.

Differential thermal analysis (DTA) can be conducted using the following method. DTA runs can be made (using an instrument such as that obtained from Netzsch Instruments, Selb, Germany under the trade designation “NETZSCH STA 409 DTA/TGA”) using a −140+170 mesh size fraction (i.e., the fraction collected between 105-micrometer opening size and 90-micrometer opening size screens). An amount of each screened sample (typically about 400 milligrams (mg)) is placed in a 100-microliter Al₂O₃ sample holder. Each sample is heated in static air at a rate of 10° C./minute from room temperature (about 25° C.) to 1100° C.

Using powder x-ray diffraction, XRD, (using an x-ray diffractometer such as that obtained under the trade designation “PHILLIPS XRG 3100” from Phillips, Mahwah, N.J., with copper K α1 radiation of 1.54050 Angstrom) the phases present in a material can be determined by comparing the peaks present in the XRD trace of the crystallized material to XRD patterns of crystalline phases provided in JCPDS (Joint Committee on Powder Diffraction Standards) databases, published by International Center for Diffraction Data. Furthermore, XRD can be used qualitatively to determine types of phases. The presence of a broad diffuse intensity peak is taken as an indication of the amorphous nature of a material. The existence of both a broad peak and well-defined peaks is taken as an indication of existence of crystalline matter within a glass matrix.

In some embodiments, the amorphous (glass) particle size is selected for the coalescing step. In some embodiments, the amorphous material has an average particle size of less than 3 micrometers (in some embodiments, less than 2, 1, 0.75, or even less than 0.5 micrometers), in order to produce glass-ceramic having an average cell size of less than 3 micrometers (in some embodiments, less than 2, 1, 0.75, or even less than 0.5 micrometers). Although not wanting to be bound by theory, it is believed that smaller cell sizes lead to improved mechanical properties for consolidated ceramics (e.g., higher strength and higher hardness).

The initially formed ceramic bodies (including glass prior to crystallization) may be larger in size than that desired. For example, it may be desirable for the ceramic particles comprising glass to be smaller sized particles. If the glass is in a desired geometric shape and/or size, size reduction is typically not needed. The glass or ceramic can be converted into smaller pieces using crushing and/or comminuting techniques known in the art, including roll crushing, jaw crushing, hammer milling, ball milling, jet milling, impact crushing, and the like. In some embodiments, the glass or ceramic can be classified using methods known to those skilled in the art such that only a fraction of the material with desired size characteristics is selected for further processing.

In some embodiments, the initially formed amorphous material (including glass prior to crystallization) may be formed at the desired average particle size (e.g., less than 3 micrometers). Spray-pyrolysis, plasma processing, and condensation from vapors can be used to form smaller particle sizes.

According to the present invention, a material selected from the group consisting of carbides, borides, nitrides, diamond and combinations thereof (including mixtures and solid solutions thereof) is dispersed in a plurality of the glass bodies that are used to form the continuous glass-ceramic matrix of the cutting tool or cutting tool insert. These dispersed phase particles may be equiaxed, elongated, plate-like, or otherwise. In some embodiments, the dispersed phase particles have an aspect ratio greater than 1:2 (in some embodiments, the aspect ratio is greater than 1:3, 1:4, 1:5, or even greater).

Exemplary dispersed phases for use in the present invention, include silicon carbide, titanium carbide, titanium nitride, boron carbide, titanium diboride, silicon nitride, and the like. Exemplary dispersed phases comprising solid solutions for use in the present invention include diamond, cubic boron nitride, titanium carbonitride, titanium boronitride, titanium boron carbonitride, and the like. The dispersed phase of the present invention is typically present in the cutting tool or cutting tool insert at an amount in the range of 15 to 50 percent by volume (in some embodiments, 20-40, or 25-35).

The dispersion of the dispersed phase can be accomplished using a variety of methods known to those skilled in art, including, for example, mixing, milling, and blending. The dispersing process can be wet or dry.

According to the present invention, glass-ceramic composites with larger dimensions (e.g., larger than 1 mm), can be prepared by consolidating the initially formed amorphous particles (e.g., glass bodies) blended with the dispersed phase. In some embodiments, articles can be made for example, via consolidation (i.e., coalescing) of the glass bodies at temperatures above glass transition temperature. This coalescing step in essence forms a larger sized body from two or more smaller particles. For instance, the glass undergoes glass transition (T_{g}) before significant crystallization occurs (Tₓ) as evidenced by the existence of an endotherm (T_{g} at lower temperature than an exotherm (Tₓ). The temperature and pressure used for coalescing may depend, for example, upon composition of the glass and the desired density of the resulting material. The temperature should be greater than the glass transition temperature. In certain embodiments, the heating is conducted at at least one temperature in a range from about 800° C. to 1200° C. (in some embodiments, 800° C. to 1000° C., 850° C. to 1100° C., or even 900° C. to 1000° C.).

Typically, the glass bodies are under pressure (e.g., greater than zero to 1 GPa or more) during coalescence. Typically, the pressure is less than 100 MPa (15,000 psi). In one embodiment, a charge of the particles, etc. is placed into a die and hot-pressing is performed at temperatures above glass transition where viscous flow of glass leads to coalescence into a relatively large part. Examples of typical coalescing techniques include hot pressing, hot isostatic pressing, hot extrusion, hot forging and the like (e.g., sintering, plasma assisted sintering). For example, particles comprising glass (obtained, for example, by crushing) (including beads and microspheres), fibers, etc. may formed into a larger particle size. Coalescing may also result in a body shaped into a desired form (e.g., a cutting tool or cutting tool insert). Additional dimensioning and/or finishing of the coalesced composite body may be desired and can be accomplished using techniques known in the art. In some embodiments, such dimensioning or finishing is done before the heat-treatment process. Coalescing of the glass may also be accomplished by a variety of methods, including pressure-less or pressure sintering, forging, hot extrusion, etc.).

In some embodiments, coalescing can be conducted in a gaseous atmosphere (e.g., nitrogen) at a pressure greater than 1.1 atm. (in some embodiments, at a pressure greater than 1.25 atm., 1.5 atm., 2 atm., 5 atm., or even greater than 10 atm.) sufficient to increase the rate of densification of the glass as compared to the same glass heated in the same manner except the pressure during the later heating is conducted in an atmosphere at a pressure of 1.0 atm., and wherein the gaseous atmosphere at a pressure greater than 1.1 atm. (in some embodiments, at a pressure greater than 1.25 atm., 1.5 atm., 2 atm., 5 atm., or even greater than 10 atm.) is in direct contact with at least a portion of the outer surface of at least a portion the glass being consolidated (see, for example, application having U.S. Ser. No. 10/901,638, filed Jul. 29, 2004).

In the present invention, the coalesced article is heat-treated to form an at least partially crystalline article. In general, heat-treatment can be carried out in any of a variety of ways, including those known in the art for heat-treating glass to provide glass-ceramics. For example, heat-treatment can be conducted in batches, for example, using resistive, inductively or gas heated furnaces. In some embodiments, the heating of the glass bodies above the T_{g} and the heat-treating of the composite body are accomplished in one step.

The time at the elevated temperature may range from a few seconds (in some embodiments, even less than 5 seconds) to a few minutes to several hours. The temperature typically ranges from the Tₓ of the glass to 1600° C., more typically from 900° C. to 1600° C., and in some embodiments, from 1200° C. to 1500° C. It is also within the scope of the present invention to perform some of the heat-treatment in multiple steps (e.g., one for nucleation, and another for crystal growth; wherein densification also typically occurs during the crystal growth step). When a multiple step heat-treatment is carried out, it is typically desired to control either or both the nucleation and the crystal growth rates. In general, during most ceramic processing operations, it is desired to obtain maximum densification without significant crystal growth. Although not wanting to be bound by theory, in general, it is believed in the ceramic art that larger crystal sizes lead to reduced mechanical properties while finer average crystallite sizes lead to improved mechanical properties (e.g., higher strength and higher hardness). In particular, it is very desirable to form ceramics with densities of at least 90, 95, 97, 98, 99, or even at least 100 percent of theoretical density, wherein the average crystal sizes are less than 0.15 micrometer, or even less than 0.1 micrometer.

In some embodiments of the present invention, the glasses or ceramics comprising glass may be annealed prior to heat-treatment. In such cases annealing is typically done at a temperature less than the Tₓ of the glass for a time from a few seconds to few hours or even days. Typically, the annealing is done for a period of less than 3 hours, or even less than an hour. Optionally, annealing may also be carried out in atmospheres other than air. Furthermore, different stages (i.e., the nucleation step and the crystal growth step) of the heat-treatment may be carried out under different atmospheres. It is believed that the T_{g} and Tₓ, as well as the Tₓ-T_{g} of glasses according to this invention may shift depending on the atmospheres used during the heat treatment.

One skilled in the art can determine the appropriate conditions from a Time-Temperature-Transformation (TTT) study of the glass using techniques known in the art. One skilled in the art, after reading the disclosure of the present invention, should be able to provide TTT curves for glasses used to make glass-ceramics utilized in the present invention, determine the appropriate nucleation and/or crystal growth conditions to provide glass-ceramics utilized in the present invention.

Heat-treatment may occur, for example, by feeding the material directly into a furnace at the elevated temperature. Alternatively, for example, the material may be fed into a furnace at a much lower temperature (e.g., room temperature) and then heated to desired temperature at a predetermined heating rate. It is within the scope of the present invention to conduct heat-treatment in an atmosphere other than air. In some cases it might be even desirable to heat-treat in a reducing atmosphere(s). Also, for, example, it may be desirable to heat-treat under gas pressure as in, for example, hot-isostatic press, or in gas pressure furnace. Although not wanting to be bound by theory, it is believed that atmospheres may affect oxidation states of some of the components of the glasses and glass-ceramics. Such variation in oxidation states can bring about varying coloration of glasses and glass-ceramics. In addition, nucleation and crystallization steps can be affected by atmospheres (e.g., the atmosphere may affect the atomic mobilities of some species of the glasses).

It is also within the scope of the present invention to conduct additional heat-treatment to further improve desirable properties of the material. For example, hot-isostatic pressing may be conducted (e.g., at temperatures from about 900° C. to about 1400° C.) to remove residual porosity, increasing the density of the material.

Typically, glass-ceramics are stronger than the glasses from which they are formed. Hence, the strength of the material may be adjusted, for example, by the degree to which the glass is converted to crystalline ceramic phase(s). Alternatively, or in addition, the strength of the material may also be affected, for example, by the number of nucleation sites created, which may in turn be used to affect the number, and in turn the size of the crystals of the crystalline phase(s). For additional details regarding forming glass-ceramics, see, for example, Glass-Ceramics, P. W. McMillan, Academic Press, Inc., 2^{nd} edition, 1979.

As compared to many other types of ceramic processing (e.g., sintering of a calcined material to a dense, sintered ceramic material), there is relatively little shrinkage (typically, less than 30 percent by volume; in some embodiments, less than 20 percent, 10 percent, 5 percent, or even less than 3 percent by volume) during crystallization of the glass to form the glass-ceramic. The actual amount of shrinkage depends, for example, on the composition of the glass, the heat-treatment time, the heat-treatment temperature, the heat-treatment pressure, the density of the glass being crystallized, the relative amount(s) of the crystalline phases formed, and the degree of crystallization. The amount of shrinkage can be measured by conventional techniques known in the art, including by dilatometry, Archimedes method, or measuring the dimensions of the material before and after heat-treatment. In some cases, there may be some evolution of volatile species during heat-treatment.

In some embodiments, the relatively low shrinkage feature may be particularly advantageous. For example, articles may be formed in the glass phase to the desired shapes and dimensions (i.e., in near-net shape), followed by heat treatment to at least partially crystallize the glass. As a result, substantial cost savings associated with the manufacturing and machining of the crystallized material may be realized.

In another aspect, for example, during heat-treatment of some exemplary glasses for making glass-ceramics utilized in the present invention, formation of phases such as La₂Zr₂O₇ and/or cubic/tetragonal ZrO₂, in some cases monoclinic ZrO₂, may occur at temperatures above about 900° C. Although not wanting to be bound by theory, it is believed that zirconia-related phases are the first phases to nucleate from the glass. Formation of Al₂O₃, ReAlO₃ (wherein Re is at least one rare earth cation), ReAl₁₁O₁₈, Re₃Al₅O₁₂, Y₃Al₅O₁₂, etc. phases are believed to generally occur at temperatures above about 925° C. Typically, crystallite size during this nucleation step is on order of nanometers. For example, crystals as small as 10-15 nanometers have been observed. For at least some embodiments, heat-treatment at about 1300° C. for about 1 hour provides a full crystallization. In general, heat-treatment times for each of the nucleation and crystal growth steps may range of from a few seconds (in some embodiments, even less than 5 seconds) to several minutes to an hour or more.

The average crystal size can be determined by the line intercept method according to the ASTM standard E 112-96 “Standard Test Methods for Determining Average Grain Size”. The sample is mounted in mounting resin (such as that obtained under the trade designation “TRANSOPTIC POWDER” from Buehler, Lake Bluff, Ill.) typically in a cylinder of resin about 2.5 cm in diameter and about 1.9 cm high. The mounted section is prepared using conventional polishing techniques using a polisher (such as that obtained from Buehler, Lake Bluff, Ill. under the trade designation “EPOMET 3”). The sample is polished for about 3 minutes with a diamond wheel, followed by 5 minutes of polishing with each of 45, 30, 15, 9, 3, and 1-micrometer slurries. The mounted and polished sample is sputtered with a thin layer of gold-palladium and viewed using a scanning electron microscopy (such as Model JSM 840A from JEOL, Peabody, Mass.). A typical back-scattered electron (BSE) micrograph of the microstructure found in the sample is used to determine the average crystallite size as follows. The number of crystallites that intersect per unit length (N_{L}) of a random straight line drawn across the micrograph are counted. The average crystallite size is determined from this number using the following equation.

$$Average Crystal Size = \frac{1.5}{{N}_{L} M} ,$$

where N_{L} is the number of crystallites intersected per unit length and M is the magnification of the micrograph.

In another aspect, glass-ceramics utilized in the present invention may comprise at least 1, 2, 3, 5, 10, 15, 20, 25, 30, 35, 40, 45, 50, 55, 60, 65, 70, 75, 80, 85, 90, 95, 97, 98, 99, or even 100 percent by volume crystallites. The crystallites present in glassceramics utilized in the present invention may have an average size of less than 1 micrometer, less than 0.5 micrometer, less than 0.3 micrometer, less than less than 0.2 micrometer, or even less than less than 0.15 micrometer. A plurality of crystallites, typically crystallites of at least two-phases, make up the cells of the glass-ceramic.

Examples of crystalline phases which may be present in ceramics according to the present invention include: alumina (e.g., alpha and transition aluminas), REO, Y₂O₃, HfO₂, ZrO₂ (e.g., cubic ZrO₂ and tetragonal ZrO₂), one or more other metal oxides such as BaO, CaO, Cr₂O₃, CoO, CuO, Fe₂O₃, GeO₂, Li₂O, MgO, MnO, NiO, Na₂O, P₂O₅, Sc₂O₃, SiO₂, Bi₂O₃, SrO, TeO₂, TiO₂, V₂O₅, ZnO, as well as “complex metal oxides” (including complex Al₂O₃.metal oxide (e.g., complex Al₂O₃.REO (e.g., ReAlO₃ (e.g., GdAlO₃, LaAlO₃), ReAl₁₁O₁₈ (e.g., LaAl₁₁O₁₈), and Re₃Al₅O₁₂ (e.g., Dy₃Al₅O₁₂)), complex Al₂O₃.Y₂O₃ (e.g., Y₃Al₅O₁₂), and complex ZrO₂.REO (e.g., La₂Zr₂O₇)) and combinations thereof. Typically, ceramics according to the present invention are free of eutectic microstructure features.

In some embodiments, ceramics according to the present invention further comprise ZrO₂ and/or HfO₂ up to 30 percent by weight (in some embodiments, in a range from 15 to 30 percent by weight ZrO₂ and/or HfO₂, based on the total weight of the ceramic.

It is also with in the scope of the present invention to substitute a portion of the aluminum cations in a complex Al₂O₃.metal oxide (e.g., complex Al₂O₃.REO and/or complex Al₂O₃.Y₂O₃ (e.g., yttrium aluminate exhibiting a garnet crystal structure)). For example, a portion of the Al cations in a complex Al₂O₃.Y₂O₃ may be substituted with at least one cation of an element selected from the group consisting of: Cr, Ti, Sc, Fe, Mg, Ca, Si, Co, and combinations thereof. For example, a portion of the Y cations in a complex Al₂O₃.Y₂O₃ may be substituted with at least one cation of an element selected from the group consisting of: Ce, Dy, Er, Eu, Gd, Ho, La, Lu, Nd, Pr, Sm, Th, Tm, Yb, Fe, Ti, Mn, V, Cr, Co, Ni, Cu, Mg, Ca, Sr, and combinations thereof. Further, for example, a portion of the rare earth cations in a complex Al₂O₃.REO may be substituted with at least one cation of an element selected from the group consisting of: Y, Fe, Ti, Mn, V, Cr, Co, Ni, Cu, Mg, Ca, Sr, and combinations thereof. The substitution of cations as described above may affect the properties (e.g., hardness, toughness, strength, thermal conductivity, etc.) of the ceramic.

Crystals formed by heat-treating glass to provide embodiments of glass-ceramics utilized in the present invention may be, for example, acicular equiaxed, columnar, or flattened splat-like features.

Some embodiments of glasses and glass-ceramics utilized in the present invention, and some glasses used to make such glass-ceramics, comprise at least 75 percent (in some embodiments, at least 80, 85, or even at least 90; in some embodiments, in a range from 75 to 90) by weight Al₂O₃, at least 0.1 percent (in some embodiments, at least 1, at least 5, at least 10, at least 15, at least 20, or 23.9; in some embodiments, in a range from 10 to 23.9, or 15 to 23.9) by weight La₂O₃, at least 1 percent (in some embodiments, at least 5, at least 10, at least 15, at least 20, or even 24.8; in some embodiments, in a range from 10 to 24.8, 15 to 24.8) by weight Y₂O₃, and at least 0.1 percent (in some embodiments, at least 1, at least 2, at least 3, at least 4, at least 5, at least 6, at least 7, or even 8; in some embodiments, in a range from 0.1 to 8 or 0.1 to 5, or 0.1 to 2) by weight MgO, based on the total weight of the glass or glass-ceramic, respectively.

Some embodiments of glasses and glass-ceramics utilized in the present invention, and some glasses used to make such glass-ceramics, comprise at least 75 percent (in some embodiments, at least 80, 85, or even at least 90; in some embodiments, in a range from 75 to 90) by weight Al₂O₃, and at least 1 percent (in some embodiments, at least 5, at least 10, at least 15, at least 20, or even 25; in some embodiments, in a range from 10 to 25, 15 to 25) by weight Y₂O₃, based on the total weight of the glass-ceramic or glass, respectively.

Some embodiments of glasses and glass-ceramics utilized in the present invention, and some glasses used to make such glass-ceramics, comprise at least 75 (in some embodiments, at least 80, 85, or even at least 90) percent by weight Al₂O₃, and at least 10 (in some embodiments, at least 15, 20, or even at least 25) percent by weight Y₂O₃ based on the total weight of the glass-ceramic or glass, respectively.

For some embodiments of glasses and glass-ceramics utilized in the present invention, and some glasses used to make such glass-ceramics comprising ZrO₂ and/or HfO₂, the amount of ZrO₂ and/or HfO₂ present may be at least 5, 10, 15, or even at least 20 percent by weight, based on the total weight of the glass-ceramic or glass, respectively.

Certain glasses according to the present invention may have, for example, a T_{g} in a range of about 750° C. to about 950° C.

The average hardness of the ceramics utilized in the present invention can be determined as follows. Sections of the material are mounted in mounting resin (obtained under the trade designation “TRANSOPTIC POWDER” from Buehler, Lake Bluff, Ill.) typically in a cylinder of resin about 2.5 cm in diameter and about 1.9 cm high. The mounted section is prepared using conventional polishing techniques using a polisher (such as that obtained from Buehler, Lake Bluff, Ill. under the trade designation “EPOMET 3”). The sample is polished for about 3 minutes with a diamond wheel containing 125-micrometer diamonds, followed by 5 minutes of polishing with each of 45, 30, 15, 9, 3, and 1-micrometer slurries. The microhardness measurements are made using a conventional microhardness tester (such as that obtained under the trade designation “MITUTOYO MVK-VL” from Mitutoyo Corporation, Tokyo, Japan) fitted with a Vickers indenter using a 100-gram indent load. The microhardness measurements are made according to the guidelines stated in ASTM Test Method E384 Test Methods for Microhardness of Materials (1991). The average hardness is an average of 10 measurements.

Certain glasses utilized in the present invention may have, for example, an average hardness of at least 5 GPa (in some embodiments, at least 6 GPa, 7 GPa, 8 GPa, or 9 GPa; typically in a range of about 5 GPa to about 10 GPa), and glassceramics according to the present invention or ceramics utilized in the present invention comprising glass and crystalline ceramic at least 5 GPa (in some embodiments, at least 6 GPa, 7 GPa, 8 GPa, 9 GPa, 10 GPa, 11 GPa, 12 GPa, 13 GPa, 14 GPa, 15 GPa, 16 GPa, 17 GPa, or 18 GPa (or more); typically in a range of about 5 GPa to about 18 GPa).

Certain glasses utilized in the present invention may have, for example, a thermal expansion coefficient in a range of about 5×10⁻⁶/K to about 11×10⁻⁶/K over a temperature range of at least 25° C. to about 900° C.

In some embodiments, the cutting tool or cutting tool insert, has a (true) density, sometimes referred to as specific gravity, that is typically at least 90% (in some embodiments, at least 95%, 96%, 97%, 98%, 99%, 99.5%. or even 100%) of theoretical density. Embodiments of cutting tools and cutting tool inserts according to the present invention have a porosity in the range from 0 to 10 (in some embodiments, in a range from 0 to 5, 0 to 3, or even 0 to 2) percent by volume.

In some embodiments, articles of the present invention (e.g., cutting tool, cutting tool insert), have a flexural strength of at least 300 MPa (in some embodiments, at least 400, 500, or even 600 MPa).

An exemplary cutting tool is shown in FIG. 7. Cutting tool 90 includes cutting tool inserts 91 having dispersed phase 92 distributed in a continuous glass-ceramic matrix.

In some embodiments, the cutting tool and cutting tool inserts of the present invention can be coated using materials known to those skilled in the art, including, for example, friction coatings, hard coatings, thermally conductive coatings, chemical barrier coatings, and the like. In some embodiments, these coating may comprise, for example, carbides, borides, nitrides, oxides, and combinations thereof (including mixtures and solid solutions thereof) (e.g., TiₓC_{y}N_{z}).

Advantages and embodiments of this invention are further illustrated by the following non-limiting examples, but the particular materials and amounts thereof recited in these examples, as well as other conditions and details, should not be construed to unduly limit this invention. All parts and percentages are by weight unless otherwise indicated. Unless otherwise stated, all examples contained no significant amount of As₂O₃, Bi₂O₃, B₂O₃, GeO₂, P₂O₅, SiO₂, TeO₂, V₂O₅, alkaline oxides, and alkaline earth oxides.

### EXAMPLE 1

A 50000-ml porcelain jar was charged with a mixture of various powders (as shown below in Table 1, with sources of the raw materials listed in Table 3) and 24000 grams of water and 40000 g of alumina balls (15 mm in diameter). The contents of the jar were mixed for 16 hours at 60 revolutions per minute (rpm). After the mixing, the slurry was spray-dried to produce agglomerated precursor powder with 60-90 microns agglomerate size.

After calcining the agglomerated powder at 1250° C. the powder was fed slowly (0.2 gram/second) into a propane/oxygen torch flame to melt the particles. The torch used to melt the particles, thereby generating molten droplets, was a Koshin Rikagaku burner KA-40 obtained from Koshin-Rikagaku Co. Tokyo. Japan. Propane and oxygen flow rates for the torch were as follows. For the center flame (Pre-mixed combustion), the propane flow rate was 5 standard liters per minute (SLPM) and the oxygen flow rate was 6 SLPM. For the outer flame, the propane flow rate was 15 SLPM and the oxygen flow rate was 80 SLPM. The calcined and sized particles were fed slowly (0.2 gram/second) into the torch flame which melted the particles and carried them directly into air to quench and collected in a stainless steel pan container. The particles were spherical in shape (hereinafter referred to as “beads”) and varied in size from a few micrometers up to 150 micrometers and were either transparent (i.e., amorphous) and/or opaque (i.e., crystalline), varying bead-to-bead. Especially most of beads sized 90 micron-32 micron were transparent. Larger beads and smaller beads tended to include opaque beads.

For differential thermal analysis (DTA), a material was screened to retain beads (microspheres) in the 90-125 micrometer size range. DTA runs were made (using an instrument obtained from Netzsch Instruments, Selb, Germany under the trade designation “NETZSCH STA 409 DTA/TGA”). The amount of each screened sample placed in the 100 microliter Al₂O₃ sample holder was 400 milligrams. Glass transition (T_{g}) and crystallization (Tₓ) of the material was determined by heating beads in static air at a rate of 10° C./minute from room temperature (about 25° C.) to 1300° C. These T_{g} and Tₓ values for other examples are reported in Table 1 and 2, below.

TABLE I

| | | Weight | Percent | Glass | Glass |
|---|---|---|---|---|---|
| | Batch | percent of | amorphous | transition, | Crystallization, Tx |
| Example | amounts, g | components | yield | Tg ° C. | ° C. |
| 1 | Al₂O₃: 19360 g | Al₂O₃: 38.5 | 99 | 843 | 925 |
| | La2O3: | La2O3: 33 | | | |
| | 16600 g | Gd2O3: 10 | | | |
| | Gd2O3: 5025 g | ZrO₂: 18.5 | | | |
| | ZrO₂: 9288 g | | | | |

3800 g of glass beads were mixed with 4200 g of de-ionized water and 5 g of ammonium salt of polyacrylic acid (Darvan 821A). The mixture was subjected to a two stage milling procedure. In the first step, high intensity bead milling was conducted with the use of Drais mill (type PML-H/V PU) using 1.75 mm yttria-stabilized zirconia (YSZ) as grinding media. In the second step, milling in Drais, Advantis V15-PU mill with finer YSZ media (0.3-0.4 mm) was performed. The resultant glass particles had an average particle size of 0.38 microns as determined using laser scattering method with Horiba 910 instrument.

About 50 grams of the milled glass particles was placed in a graphite die and hot-pressed using uniaxial pressing apparatus (obtained under the trade designation “HP-50”, Thermal Technology Inc., Brea, Calif.). The hot-pressing was carried out at 1300° C. in nitrogen atmosphere and 4 ksi (27.6 MPa) pressure. The resulting disk was about 48 mm in diameter, and about 5 mm thick. Additional hot-press runs were performed to make additional disks. The density of the hot-pressed material was measured using Archimedes method, and found to be about 5.5 g/cm³ which is 99% of theoretical density.

### COMPARATIVE EXAMPLE A

About 50 grams of the as made glass beads (prior to milling), prepared as described in Example 1, were placed in a graphite die and hot-pressed using uniaxial pressing apparatus (obtained under the trade designation “HP-50”, Thermal Technology Inc., Brea, Calif.) according to the same schedule used in Example 1.

Three Point Flexural Properties According to ASTM C1161 were measured using Configuration A procedure. Samples were machined to nominal thickness of 1.5 mm, width 2.0 mm and length 30 mm. The crosshead speed was set at 0.2 mm/min. In the three point bend test, the span was set at 20 mm. An Alliance MTS 100 Testframe was used in conjunction with Testworks IV software for testing and data acquisition.

Average flexure strength of Example 1 material was 563 MPa, and of the Comparative Example A material was 169 MPa.

### EXAMPLE 2

About 18g of milled beads of Example 1 were cold-pressed into a cylindrical part with 10×16 mm in diameter at 16,000 lb in a cavity of a stainless steel die. Subsequently, pressureless sintering in air was conducted in a furnace (an electrically heated furnace (obtained under the trade designation “Model KKSK-666-3100” from Keith Furnaces of Pico Rivera, Calif.)) as follows. The material was heated from room temperature (about 25° C.) to about 1375° C. at a rate of about 10° C./min. and then held at 1375° C. for about 2 hours. Additional runs were performed with the same heat-treatment schedule to make additional sintered parts. The density of the resulting sintered material was measured using Archimedes method, and found to be 5.4 g/cm³ which was about 97% of theoretical density.

### COMPARATIVE EXAMPLE B

About 18 g of beads of Comparative Example A were cold-pressed and sintered as described in Example 2. Only partial sintering was observed which precluded accurate density determination.

### EXAMPLE 3

Example 3 beads were prepared as described in Example 1, except the raw materials, the amounts of raw materials, used are listed in Table 2, below. The sources of the raw materials used are listed in Table 3, below.

TABLE 2

| | | Weight | Percent | Glass | |
|---|---|---|---|---|---|
| | Batch | percent of | amorphous | transition, | Glass |
| Example | amounts, g | components | yield | ° C. | Crystallization, ° C. |
| 3 | Al₂O₃: 6600 g | Al₂O₃: 66 | 97 | 875 | 926 |
| | Y₂O₃: 3400 g | Y₂O₃: 34 | | | |

Glass bead milling was conducted as described in Example 1 material except that 3100 g of beads and 4900 DI water was used. The average particle size after milling, determined as described in Example 1 was 0.28 microns.

About 50 grams of the milled glass particles was placed in a graphite die and hot-pressed using uniaxial pressing apparatus (obtained under the trade designation “HP-50”, Thermal Technology Inc., Brea, Calif.). The hot-pressing was carried out at 1400° C. in nitrogen atmosphere and 4 ksi (27.6 MPa) pressure. The resulting disk was about 48 mm in diameter, and about 6.2 mm thick. Additional hot-press runs were performed to make additional disks. The density of the hot-pressed material, measured by Archimedes method was found to be about 4.2 g/cm³ which is 99% of theoretical density.

TABLE 3

| Raw Material | Source |
|---|---|
| Alumina powder (Al₂O₃) | Obtained from Condea Vista, Tucson, |
| | AZ under the trade designation |
| | “APA-0.5” |
| Yttrium oxide powder (Y₂O₃) | Obtained from Molycorp Inc., |
| | Mountain Pass, CA |
| Gadolinium oxide powder (Gd₂O₃) | Obtained from Molycorp Inc., |
| | Mountain Pass, CA |
| Lanthanum oxide powder (La₂O₃) | Obtained from Molycorp Inc. |
| Yttria-stabilized zirconium | Obtained from Zirconia Sales, Inc. of |
| oxide powder (Y-PSZ) | Marietta, GA under the trade |
| | designation “HSY-3” |

### COMPARATIVE EXAMPLE C

About 50 grams of the before milling glass beads prepared as described in Example 3 were placed in a graphite die and hot-pressed using uniaxial pressing apparatus (obtained under the trade designation “HP-50”, Thermal Technology Inc., Brea, Calif.) according to the same schedule used in Example 3.

Flexural strength of materials of Example 3 and Comparative Example C was measured as described in Example 1and was found to be 579 and 123 respectively.

Ten 0.53″×0.53″×0.2″ blanks of hot-pressed milled material of Example 3 were machined from larger hot-pressed samples for evaluation of a utility of these materials for cutting tool applications.

Cutting tests were performed using heat-treated D2 steel with hardness of HRC=65 as a workpiece. The cutting behavior was observed using the following testing parameters (see Table 4)

TABLE 4

| | | | Depth per |
|---|---|---|---|
| Material | Depth of Cut | SFPM | Revolution |
| Example 3 | 0.0078 | 318 | 0.0117 |
| Example 3 | 0.0078 | 427 | 0.0117 |
| Example 3 | 0.0078 | 518 | 0.0117 |
| Example 3 | 0.0078 | 635 | 0.0117 |
| Example 3 | 0.012 | 635 | 0.0117 |

### EXAMPLE 4

A 250-ml polyethylene bottle (7.3-cm diameter) was charged with the following 50-gram mixture: 43.5 g of of milled glass beads of Example 1, 6.5 g of SiC whiskers obtained from Alfa Aesar (average diameter of 1.5 mic and length of 18 microns), 80 grams of ethanol, and 200 grams of zirconia milling media (cylindrical in shape, both height and diameter of 0.635 cm; 99.9% zirconia; obtained from Tosoh, Japan). The contents of the polyethylene bottle were milled for 10 hours at 60 revolutions per minute (rpm). After the milling, the milling media were removed and the slurry was poured onto a warm (approximately 75° C.) glass (“PYREX”) pan and dried.

About 25 grams of the dried slurry were placed in a graphite die and hot-pressed in nitrogen atmosphere, 4 ksi (27.6 MPa) pressure as follows. The material was heated from room temperature (about 25° C.) to about 945° C. at a rate of about 25° C./min. and then held at that temperature for 20 min. Subsequently, the material was heated to 1250 C at a rate of about 25 C/min and then held at that temperature for 20 min. Then, the material was heated to 1425 C at 25 C/min and held at that temperature for another 20 min.

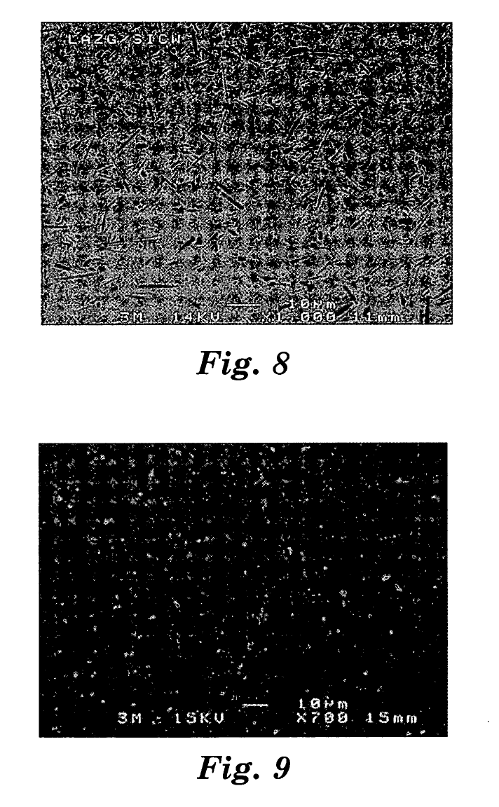

FIG. 8 is a scanning electron microscope (SEM) photomicrograph of a polished section of Example 4 materials. The polished section was prepared as described in Example 1. As seen from FIG. 8, the material contains SiC whiskers homogeneously distributed throughout.

The average hardness of the as-hot-pressed material of this example was determined as follows. Sections of the material were mounted in mounting resin (obtained under the trade designation “TRANSOPTIC POWDER” from Buehler, Lake Bluff, Ill.). The resulting cylinder of resin was about 2.5 cm in diameter and about 1.9 cm high. The mounted section was prepared using conventional polishing techniques using a polisher (obtained from Buehler, Lake Bluff, Ill. under the trade designation “ECOMET 3”). The sample was polished for about 3 minutes with a diamond wheel, followed by 5 minutes of polishing with each of 45, 30, 15, 9, 3, and 1-micrometer slurries. The microhardness measurements were made using a conventional microhardness tester (obtained under the trade designation “MITUTOYO MVK-VL” from Mitutoyo Corporation, Tokyo, Japan) fitted with a Vickers indenter using a 300-gram indent load. The microhardness measurements were made according to the guidelines stated in ASTM Test Method E384 Test Methods for Microhardness of Materials (1991), the disclosure of which is incorporated herein by reference. The average microhardness (an average of 20 measurements) of the material of this example was 16.6 Gigapascals (GPa). The average indentation toughness of the hot-pressed material was calculated by measuring the crack lengths extending from the apices of the vickers indents made using a 500 gram load with a microhardness tester (obtained under the trade designation “MITUTOYO MVK-VL” from Mitutoyo Corporation, Tokyo, Japan). Indentation toughness (K_{lC}) was calculated according to the equation:
K_{lC}=0.016(E/H)^{1/2}(P/c)^{3/2}
wherein: E=Young's Modulus of the material;

H=Vickers hardness;

P=Newtons of force on the indenter;

c=Length of the crack from the center of the indent to its end.

Samples for the toughness were prepared as described above for the microhardness test. The reported indentation toughness values are an average of 5 measurements. Crack (c) were measured with a digital caliper on photomicrographs taken using a scanning electron microscope (“JEOL SEM” (Model JSM 6400)). The average indentation toughness of the hot-pressed material was 5.8 MPa·m^{1/2}.

### EXAMPLE 5-6

Example 5 glass mixture with SiC whiskers was prepared as described in Example 4, except materials, the amounts of raw materials, used are listed in Table 5, below.

TABLE 5

| | Batch | Volume percent of |
|---|---|---|
| Example | amounts, g | components |
| 5 | Milled | Glass powder: 80 |
| | Example 3 | |
| | glass powder: | |
| | 42.06 | |
| | SiCw: 7.94 | SiCw: 20 |
| 6 | Milled | Glass powder: 70 |
| | Example 3 | |
| | glass powder: | |
| | 38 | |
| | 12 | SiCw: 30 |

About 25 grams of Example 5 and 6 dried slurry were placed in a graphite die and hot-pressed as described in the Example 4 except, temperatures at which isothermal hold was conducted were 960, 1300 and 1450 C respectively.

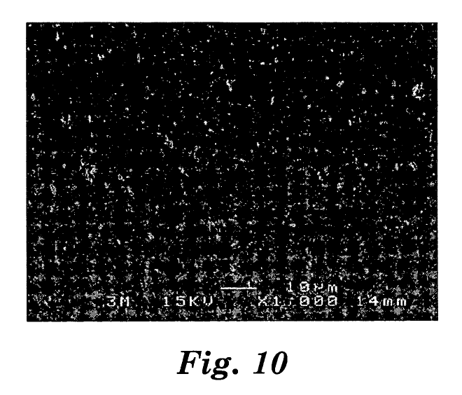

FIG. 9 is scanning electron microscope (SEM) photomicrograph of a polished section of Example 6 material located perpendicular to hot-pressing direction.

As seen in FIG. 9, a majority of SiC whiskers are homogeneously distributed throughout the sample. As shown in FIG. 9, the SiC whiskers are oriented substantially perpendicular to the pressing direction.

FIG. 10 is scanning electron microscope (SEM) photomicrograph of a polished section of Example 6 material located parallel to the hot-pressing direction.

As seen from in FIG. 10, a majority of SiC whiskers are homogeneously distributed throughout the sample. As shown in FIG. 10, the SiC whiskers are oriented substantially perpendicular to the pressing direction.

Not wishing to be bound by theory, it is believed that during glass consolidation which takes place by viscous flow mechanism, SiC whiskers realign in a low viscosity fluid under the action of hot-pressing force. As a result of this process, majority of the whiskers orient themselves in such a manner that their longest dimension is substantially perpendicular to the pressing direction.

Hardness and toughness of Example 3, 5 and 6 hot-pressed materials was measured as described in Example 4. The results are shown in Table 6.

TABLE 6

| Material | Hardness, GPa | K_{Ic}, MPa * m^{1/2} |
|---|---|---|
| Ex. 3 | 19.1 | 3.7 |
| Ex. 5 | 20.4 | 4.9 |
| Ex. 6 | 21.3 | 5.1 |

Various modifications and alterations of this invention will become apparent to those skilled in the art without departing from the scope and spirit of this invention, and it should be understood that this invention is not to be unduly limited to the illustrative embodiments set forth herein.

What is claimed is:

1. A cutting tool insert comprising:
a continuous glass-ceramic matrix comprising at least 35 percent by weight Al₂O₃, based on the total weight of the glass-ceramic matrix, and a metal oxide other than Al₂O₃, wherein the glass-ceramic matrix contains not more than 10 percent by weight collectively As₂O₃, B₂O₃, Bi₂O₃, GeO₂, P₂O₅, SiO₂, TeO₂, and V₂O₅, based on the total weight of the glass-ceramic matrix, and wherein the glass-ceramic matrix comprises a plurality of cells having an average cell size of less than 3 micrometers; and
a dispersed phase selected from the group consisting of carbides, borides, nitrides, diamond, and combinations thereof.

2. The cutting tool insert of claim 1 wherein the dispersed phase comprises a plurality of elongated particle having an aspect ratio of at least 5:1.

3. The cutting tool insert of claim 1 wherein the dispersed phase comprises silicon carbide.

4. The glass-ceramic of claim 1 wherein the cutting tool insert has x, y, and z dimensions each perpendicular to each other, and each of the x and y dimensions is at least 5 mm.

5. The cutting tool insert according to claim 1 wherein the metal oxide other than Al₂O₃ is Y₂O₃.

6. The cutting tool insert according to claim 1 wherein the metal oxide other than Al₂O₃ is ZrO₂.

7. The cutting tool insert according to claim 1 wherein the metal oxide other than Al₂O₃ is REO.

8. The cutting tool insert according to claim 1 wherein the plurality of cells have an average cell size of less than 2 micrometers.

9. The cutting tool insert according to claim 1 wherein the plurality of cells have an average cell size of less than 1 micrometer.

10. The cutting tool insert according to claim 1 wherein the plurality of cells have an average cell size of less than 0.5 micrometer.

11. The cutting tool insert according to claim 1 wherein the cutting tool insert has a flexural strength of at least 300 MPa.

12. The cutting tool insert according to claim 2 wherein the elongated particles are substantially oriented in at least one plane.

13. A cutting tool comprising:
a continuous glass-ceramic matrix comprising at least 35 percent by weight Al₂O₃, based on the total weight of the glass-ceramic matrix, and a metal oxide other than Al₂O₃, wherein the glass-ceramic matrix contains not more than 10 percent by weight collectively As₂O₃, B₂O₃, Bi₂O₃, GeO₂, P₂O₅, SiO₂, TeO₂, and V₂O₅, based on the total weight of the glass-ceramic matrix, and wherein the glass-ceramic matrix comprises a plurality of cells having an average cell size of less than 3 micrometers; and
a dispersed phase selected from the group consisting of carbides, borides, nitrides, diamond, and combinations thereof.

14. The cutting tool of claim 13 wherein the dispersed phase is an elongated particle having an aspect ratio of at least 5:1.

15. The cutting tool of claim 13 wherein the dispersed phase comprises silicon carbide.

16. The cutting tool of claim 13 wherein the cutting tool insert has x, y, and z dimensions each perpendicular to each other, and each of the x and y dimensions is at least 5 mm.

17. The cutting tool according to claim 13 wherein the plurality of cells have an average cell size of less than 1 micrometer.

18. The cutting tool according to claim 13 wherein the cutting tool has a flexural strength of at least 300 MPa.

19. A method of making an article comprising:
providing a plurality of glass bodies having an average particle size of less than 3 micrometers, wherein the glass bodies comprises at least two different metal oxides, wherein the glass bodies have a T_{g} and Tₓ, and wherein the difference between the T_{g} and the Tₓ of the glass bodies is at least 5K, the glass bodies containing less than 20% by weight SiO₂, less than 20% by weight B₂O₃, and less than 40% by weight P₂O₅;
dispersing a material selected from the group consisting of carbides, borides, nitrides, diamond, and combinations thereof in the plurality of glass bodies;
heating the glass bodies above the T_{g} and coalescing at least a portion of the plurality of glass bodies to form a composite body; and
heat-treating the composite body to provide a cutting tool insert.

20. The method according to claim 19 wherein the glass bodies have an average particle size of less than 2 micrometers.

21. The method according to claim 19 wherein the glass bodies have an average particle size of less than 1 micrometer.

22. The method according to claim 19 wherein the glass bodies have an average particle size of less than 0.5 micrometer.

23. The method according to claim 19 further comprising milling a plurality of precursor glass bodies to form the plurality of glass bodies.

24. The method according to claim 19 further comprising heat-treating the article to provide a glass-ceramic.

25. The method according to claim 19 wherein the glass bodies comprise at least one of Al₂O₃, REO, or ZrO₂.

26. The method according to claim 19 wherein heating the glass bodies above the T_{g} and coalescing at least a portion of the plurality of glass bodies occurs at a pressure that does not exceed 100 MPa.

27. The method according to claim 19 further comprising shaping at least one surface of the cutting tool insert to form a cutting surface.

28. The method according to claim 19 wherein the dispersed material is an elongated particle having an aspect ratio of at least 5:1.

29. A cutting tool made according to the method of claim 19.

30. A cutting tool insert made according to the method of claim 19.

31. A cutting tool insert comprising:
a continuous glass-ceramic matrix; and
a dispersed phase selected from the group consisting of carbides, borides, nitrides, diamond, and combinations thereof;
wherein the cutting tool insert has a hardness of at least 15 GPa and a flexural strength of at least 400 MPa.

32. The cutting tool insert of claim 31 wherein the glass-ceramic matrix comprises a plurality of cells having an average cell size of less than 3 micrometers.

33. A cutting tool comprising:
a continuous glass-ceramic matrix; and
a dispersed phase selected from the group consisting of carbides, borides, nitrides, diamond, and combinations thereof,
wherein the cutting tool insert has a hardness of at least 15 GPa and a flexural strength of at least 400 MPa.

34. The cutting tool of claim 33 wherein the glass-ceramic matrix comprises a plurality of cells having an average cell size of less than 3 micrometers.
